(19) United States
(12) Patent Application Publication
(10) Pub. No.: US 2011/0194791 A1
(43) Pub. Date: Aug. 11, 2011

(54) PULL-OUT GUIDE FOR FURNITURE AND METHOD FOR PRODUCING A PULL-OUT GUIDE

(75) Inventors: Peter Jahrling, Bunde (DE); Andreas Hoffmann, Bunde (DE)

(73) Assignee: PAUL HETTICH GMBH & CO. KG, Kirchlengern (DE)

(21) Appl. No.: 13/120,926

(22) PCT Filed: Oct. 16, 2009
(86) PCT No.: PCT/EP2009/063527

§ 371 Date: Mar. 25, 2011

(30) Foreign Application Priority Data
Oct. 28, 2008 (DE) 10 2008 053 504.4

(51) Int. Cl. F16C 29/00; B23P 17/00

(52) U.S. Cl. 384/26; 29/898.1

(57) ABSTRACT

A pull-out guide for furniture includes a guide rail configured to be mounted on a furniture body and at least one sliding rail displaceably mounted via rolling elements on the guide rail. The rolling elements are held in a rolling element cage, which cage includes a lubricant-containing material.

This application is a national stage of International Application PCT/EP2009/063527, filed Oct. 16, 2009, and claims benefit of and priority to German Patent Application No. 10 2008 053 504.4, filed May 13, 2008, the content of which Applications are incorporated by reference herein.

### BACKGROUND AND SUMMARY

The present disclosure relates to a pull-out guide for furniture. The pull-out guide includes a guide rail that can be mounted on a furniture body and further includes at least one sliding rail that is displaceably mounted via rolling elements on the guide rail. The present disclosure also relates to a method for producing a pull-out guide.

It is known that pull-out guides are lubricated to ensure smooth mobility of the displaceably held rails, so that the rolling elements have improved running properties along the running paths and protection from corrosion is increased. Moreover, the running noises can be dampened via lubrication with grease. The problem occurs in pull-out guides that they are not sealed and there might be impairments by penetrating foreign bodies or dirt. Moreover, the lubrication can inadvertently be removed. The application of the grease usually occurs during production, with metering being difficult because a large part of the grease is applied to surfaces that will never come into contact with the rolling elements. This requires a large amount of material, wherein an excessive amount of grease can negatively influence the running quality and the function.

The present disclosure relates to, among other things, a pull-out guide for furniture which has optimized lubrication.

The present disclosure thus relates to a pull-out guide that includes a guide rail configured to be mounted on a furniture body and at least one sliding rail displaceably mounted via rolling elements on the guide rail. The rolling elements are held in a rolling element cage, which cage includes a lubricant-containing material.

Thus, a pull-out guide for furniture is provided in which the rolling elements are held in a rolling element cage which includes, at least partly, a material containing a lubricant. The lubrication of the rolling elements can occur in a purposeful matter at locations where there is a need for lubrication, which are the moved surfaces of the rolling elements which then ensure a certain wetting of the running surfaces on the rails. It is prevented that lubricant can reach surface areas which do not need to be lubricated. Moreover, there can be a precise metering of the lubricant over a long period of time because the application of the lubricant does not occur only once during production but continuously during the use of the pull-out guide.

Diffusion is based on thermal motion of particles. Particles can be atoms, molecules or charge carriers. The present disclosure relates to lubricant molecules. Macroscopic mass transfer is caused in such a way that, in the case of uneven distribution, statistically more particles will move from the region of high concentration to the region of low concentration than, rather vice-versa. A lubrication of the pull-out guide, according to the present disclosure, is thus ensured up to equalisation of concentration. The described diffusion processes can be based on Fick's laws.

According to an embodiment of the present disclosure, the rolling elements slide along the lubricant-containing material with one contact surface. The contact surface of the rolling elements can be wetted with lubricant, with the rolling elements ensuring the distribution over the running paths. The lubricant-containing material can lubricate the rolling elements for a long period of time because the lubricant contained in the material will diffuse to the surface and therefore a low amount of the lubricant is transferred to the rolling element during each movement of the rolling elements. This purposeful lubrication of the rolling elements leads to an optimal lubrication behavior. In particular, lubricants of low viscosity can be used, for example, oils which cannot be used in a one-off lubrication during the production of the pull-out guide.

A large temperature range for the use of the pull-out guides can be covered through a low viscosity of the lubricant. As a result, the same pull-out guides can be used in freezers as well as in baking ovens. By incorporating the lubricant in the lubricant-containing material, new lubricant will pass by diffusion to the contact surface onto the rolling element after the utilization of the baking oven functions, such as the pyrolysis function, and will thus cause its lubrication. The lubricant may therefore, be used in a range of over 200° C., especially also in a range of over 400° C. In the freezing range, the lubricant may be used in a range of less than −15° C., especially also in a range of lower than −40° C.

A substance such as wax can also be considered for example as a lubricant-containing material which gradually releases the lubricant.

In an embodiment according to the present disclosure, the lubricant-containing material is a porous body made of sintered material or plastic in which oil is incorporated as a lubricant. The incorporated oil is allowed to flow through capillaries or separately installed channels. The body can then absorb lubricant in the manner of a sponge and gradually release the same upon actuation of the pull-out guide.

The rolling elements are incorporated in a single rolling element cage, for example, which cage consists completely of the lubricant-containing material. The rolling element cage can be made of plastic by an injection molding method, with the rolling elements being spray-coated.

All materials can be used as carrier materials for the rolling element cage which have a higher strength than the lubricant-containing material. They must withstand loads during the use of the pull-out guide.

In another embodiment according to the present disclosure, the rolling element cage comprises a plurality of pockets in which one respective rolling element holder made of a lubricant-containing material is inserted. At least one rolling element is rotatably mounted in said rolling element holder. The rolling element holder can be fixed to the rolling element cage in a positive, non-positive or firmly bonded manner, with several rolling elements being incorporated in a rolling element holder.

In another embodiment according to the present disclosure, the rolling element cage is arranged in the manner of a strip and comprises individual receivers for the rolling elements. At least the region of the receivers is coated with the lubricant-containing material, so that optimal lubrication of the rolling elements is ensured. Lubrication, by protruding strips or projections, can also ensure long-term lubrication.

In a method, in accordance with the present disclosure, for producing a pull-out guide, a guide rail and at least one sliding rail are produced at first. Furthermore, at least one porous body, which forms at least a part of a rolling element cage, is impregnated with lubricant. The guide rail, the rolling element cage and the at least one sliding rail are then assembled into a pull-out guide, with lubrication of the rolling elements and the running surfaces occurring by movement of the at least one sliding rail relative to the guide rail. In addition, the pull-out guide can be provided with a middle rail that extends the pull-out in order to realize a full drawer extension. The middle rail is then arranged between the guide rail and the sliding rail.

In order to accelerate the impregnation of the lubricant-containing material with lubricant, it is possible to use a high-pressure process such as boiler pressure impregnation. In this case, the lubricant is pressed at pressures of up to 15 bars into the porous material in order to obtain the lubricant-containing material.

A lubrication of the pull-out guide is triggered by each actuation of the pull-out guide. The lubricant is transferred to the running paths of the pull-out guide by the movement of the rolling elements or the pull-out guide. The concentration of lubricant close to the contact surface will decrease in the lubricant-containing material as a result of the transfer of lubricant on the contact surface to the rolling element or running path of the pull-out guide. As a result of the diffusion processes, as already described above, there is an equalization of lubricant concentration in the lubricant-containing material over a certain period of time. These processes are triggered again by each actuation of the pull-out guide.

According to the present disclosure, the rolling element cage comprises a strip-like carrier material to which a porous body is fixed either by coating or mechanically. This allows the production of a pull-out guide with a low mass, especially when plastic is used as a carrier material. The carrier material can be coated on opposite end sides with a porous body in order to form pockets for receiving the rolling elements in the porous bodies.

According to the present disclosure, it is alternatively possible to produce the porous bodies as single components made of ceramic or metallic materials.

Other aspects of the present disclosure will become apparent from the following descriptions when considered in conjunction with the accompanying drawings.

### BRIEF DESCRIPTION OF THE DRAWINGS

FIGS. 1 to 3 show several views of a first embodiment of a pull-out guide, in accordance with the present disclosure.

FIGS. 4 to 8 show several views of a second embodiment of a roller element cage of a pull-out guide, in accordance with the present disclosure.

FIGS. 9 to 13 show several views of a third embodiment of a rolling element cage in accordance with the present disclosure.

FIGS. 14 to 16 show several views of a fourth embodiment of a rolling element cage in accordance with the present disclosure.

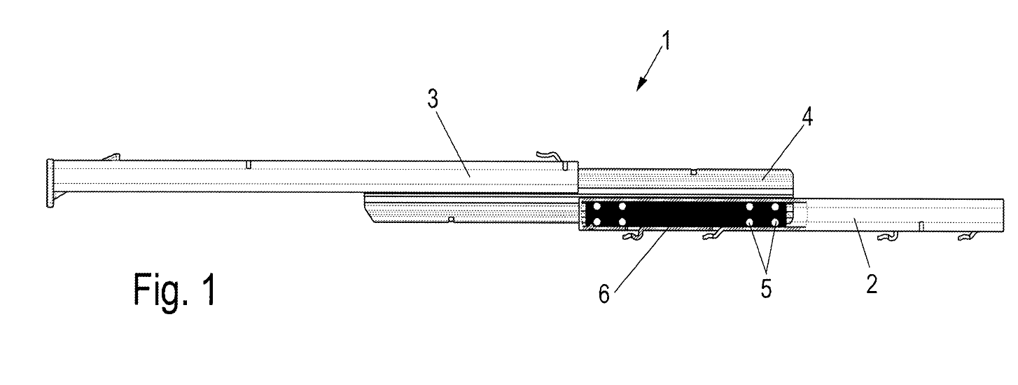

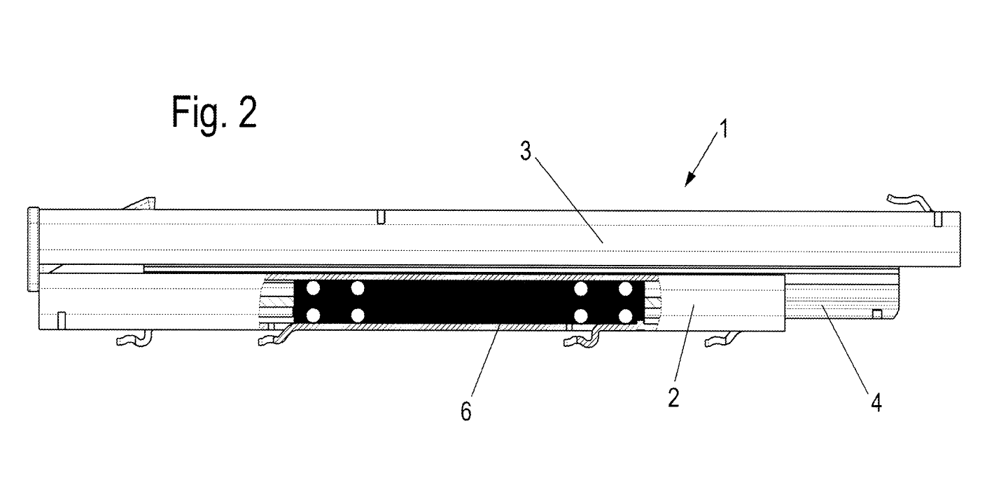

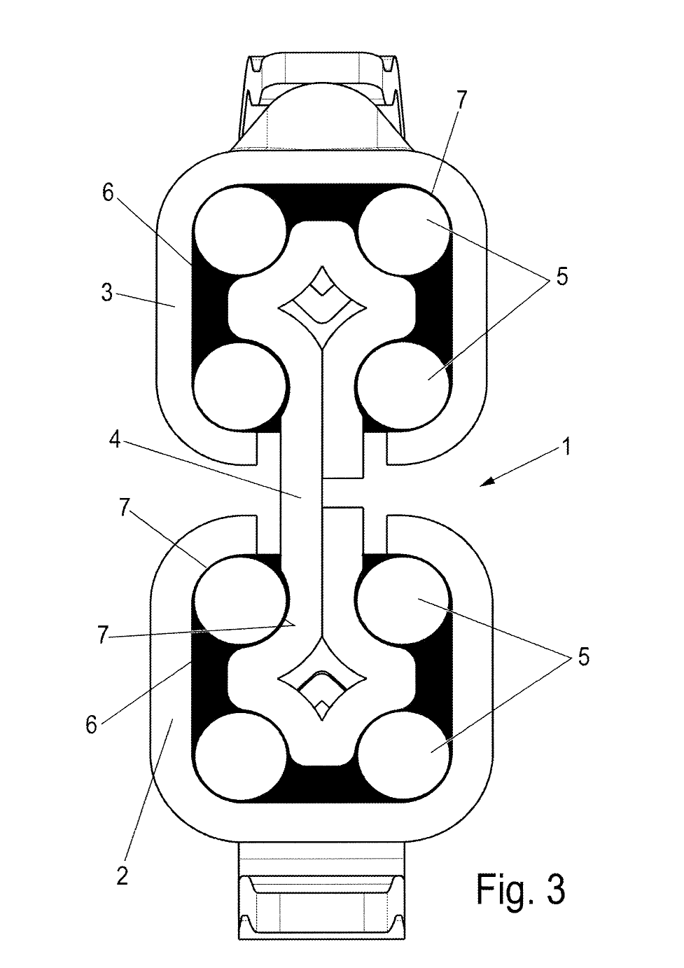

### DETAILED DESCRIPTION

A pull-out guide 1 comprises a guide rail 2 and a sliding rail 3 which can be mounted on a furniture body and on which a drawer, or a similar sliding element, can be mounted. The sliding rail 3 is mounted on a middle rail 4 via rolling elements 5, which middle rail 4 is displaceably held on its part on the guide rail 2 via rolling elements 5. It is within the scope of the present disclosure to mount the sliding rail 3 on the guide rail 2 directly via the rolling elements 5 without a middle rail 4.

In an embodiment of the pull-out guide 1, the rolling elements 5 are mounted between the guide rail 2 and the middle rail 4, as well as between the middle rail 4 and the sliding rail 3, in a rolling element cage 6 which is made integrally of a lubricant-containing material. The rolling element cage 6 is made of a porous body made of sintered material or plastic in which oil is incorporated as a lubricant. The rolling elements 5 are spray-coated by the lubricant-containing material.

The rolling element cage 6 thus substantially fills an interior space between the guide rail 2 and the middle rail 4, as well as between the middle rail 4 and the sliding rail 3, so that the rolling elements 5 are arranged to be protected against soiling. Moreover, the lubricant, or oil, can reach the contact surfaces of the rolling elements 5 via capillaries or respective channels in the rolling element cage 6, which rolling elements 5 will then distribute the lubricant to miming paths 7. The rolling elements 5 are twisted during each movement of the pull-out guide 1, so that the contact surfaces of the rolling elements 5, which rest on the rolling element cage 6, are wetted slightly with lubricant. Lubrication thus occurs continuously during the entire service life of the pull-out guide 1, which can be maintained over very long period of time.

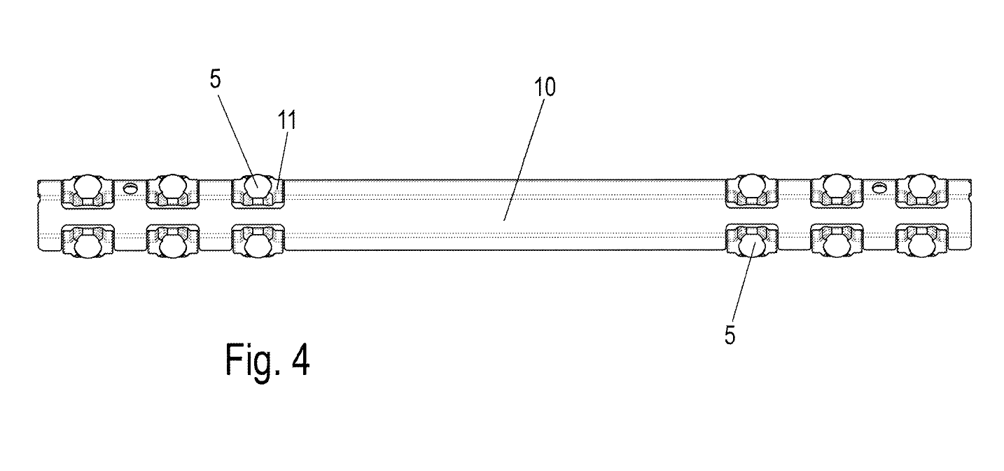

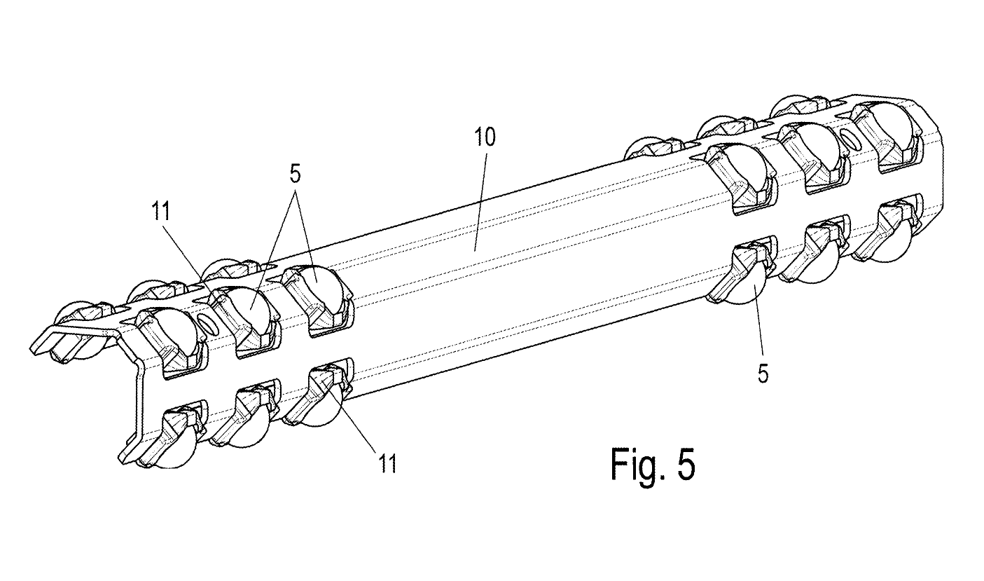

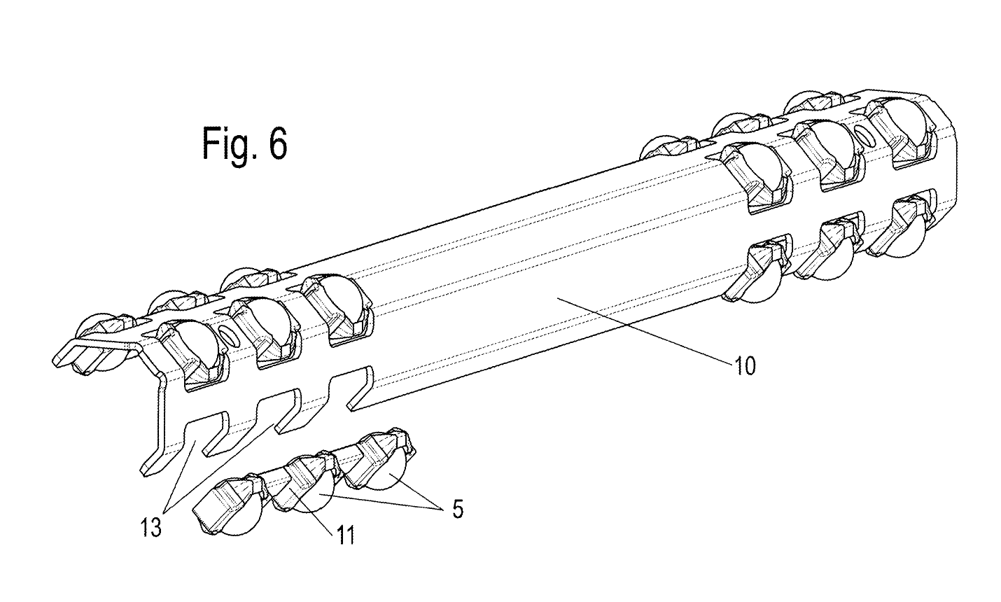

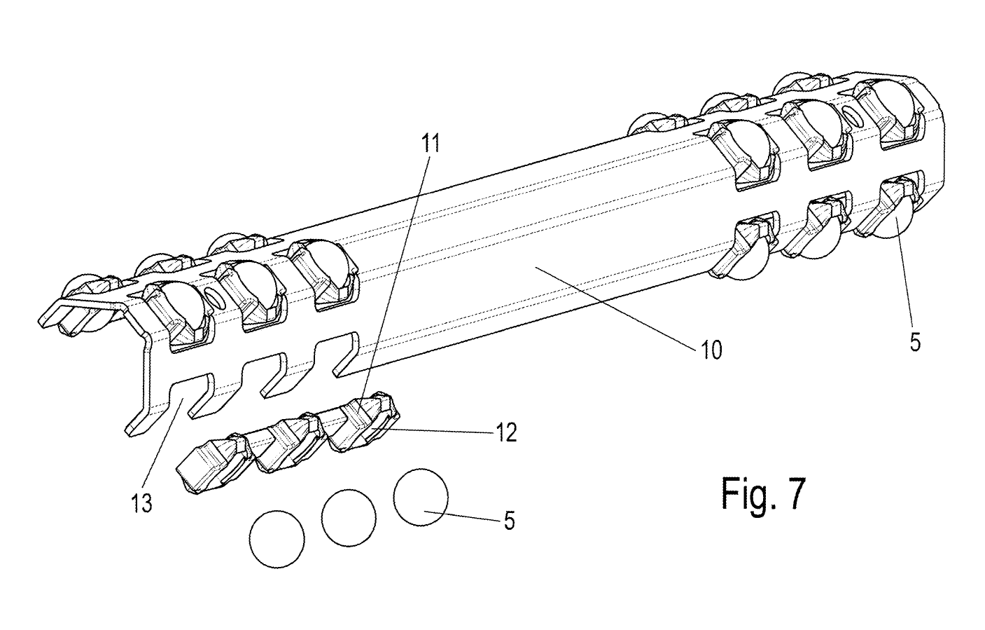

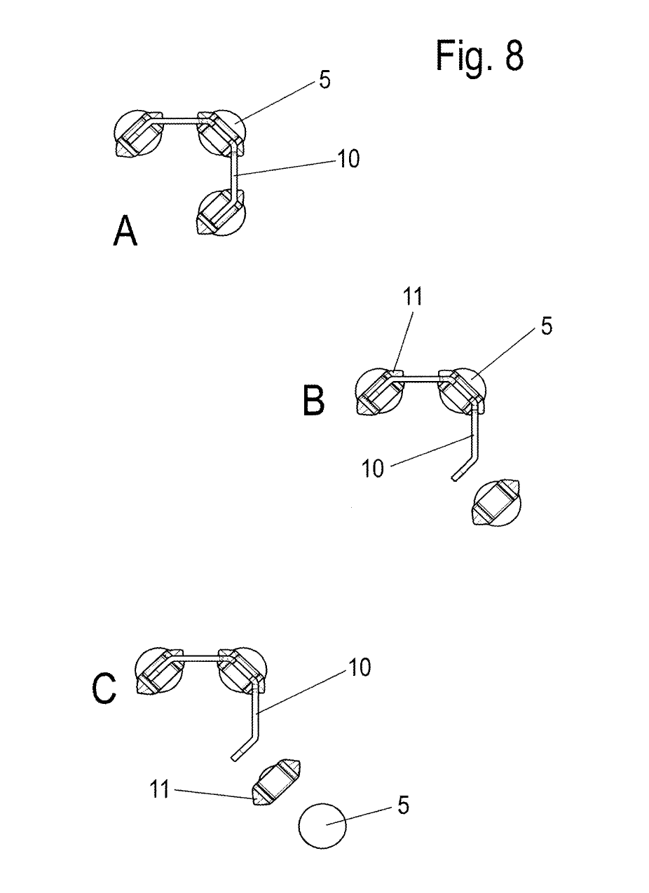

FIGS. 4 to 8 show another embodiment of a rolling element cage 10 which comprises a strip made of a carrier material of higher strength, in which individual recesses 13 are arranged on two opposite ends. Three mutually distanced recesses 13 are provided on each side in the longitudinal direction, in which one respective spherical rolling element 5 is accommodated. Three rolling elements 5 are respectively provided on the rolling element cage 10 in a plane perpendicular to the longitudinal direction. Rolling element holders 11 made of a lubricant-containing material are provided in each recess 13 on the rolling element cage 10. The rolling element holders 11 can be fixed to the recesses 13 of the rolling element cage 10 in a positive, non-positive or firmly bonded manner. As is shown in FIGS. 7 and 8A to 8C, the spherical rolling elements 5 can be inserted at first into receivers 12 of the rolling element holders 11. The rolling elements 5 can be fixed there in a latched manner, with the rolling element holder 11 being arranged in such a way that three receivers 12 are provided and the rolling element holder 11 is mounted on respective recesses 13 of the rails of the rolling element cage 10. It is within the scope of the present disclosure to accommodate more than three rolling elements 5, for example, six or nine rolling elements 5.

In this embodiment, the rolling elements 5 rest with a contact surface on a lubricant-containing material, so that during the use of the pull-out guide 1 and movement of the rolling elements 5 there will be continuous lubrication.

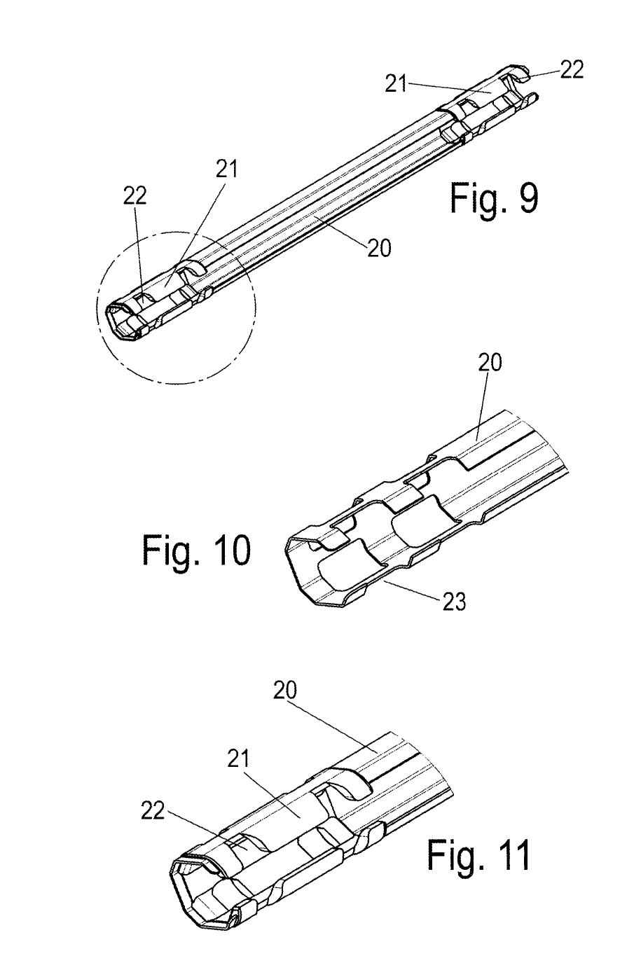

In an embodiment, according to the present disclosure, as shown in FIGS. 9 to 13, a rolling element cage 20 is provided in the form of a strip-like rail made of a carrier material of higher strength, on which recesses 22 are provided at the end side for accommodating rolling elements 5. A coating made of a lubricant-containing material is provided on opposite sides of the rolling element cage 20 at an end section 21. FIG. 10 shows a rail made of a carrier material of higher strength of the rolling element cage 20 and is shown in a raw state, or as a raw part. As shown in FIG. 10, the recesses 23 are provided with a far wider configuration in the component than the recesses, or receivers, 22 for the rolling element 5. The raw part is then coated subsequently in an end section 21 with the lubricant-containing material, so that the receivers 22 are then formed for the rolling elements 5 and a contact surface of the rolling elements 5 rests on the lubricant-containing material.

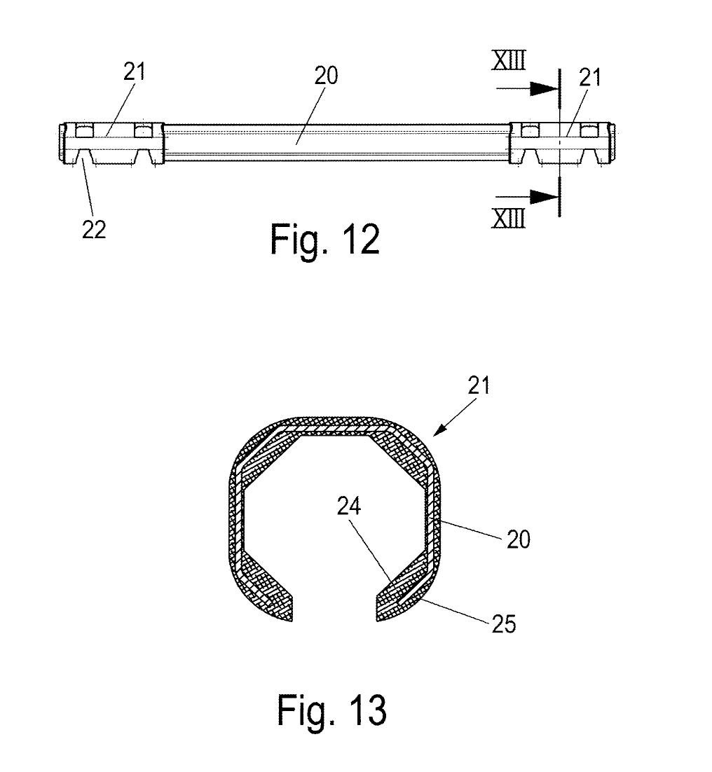

As can be seen from FIGS. 12 and 13, the U-shaped strip, made of a carrier material of higher strength for the coating, merely forms a support body, with the coating having a different thickness and comprising a larger thickness on an inside 24 than on an outside 25. A larger layer thickness can thus be provided in a purposeful way in regions adjacent to the rolling elements 5, which enables longer lubrication.

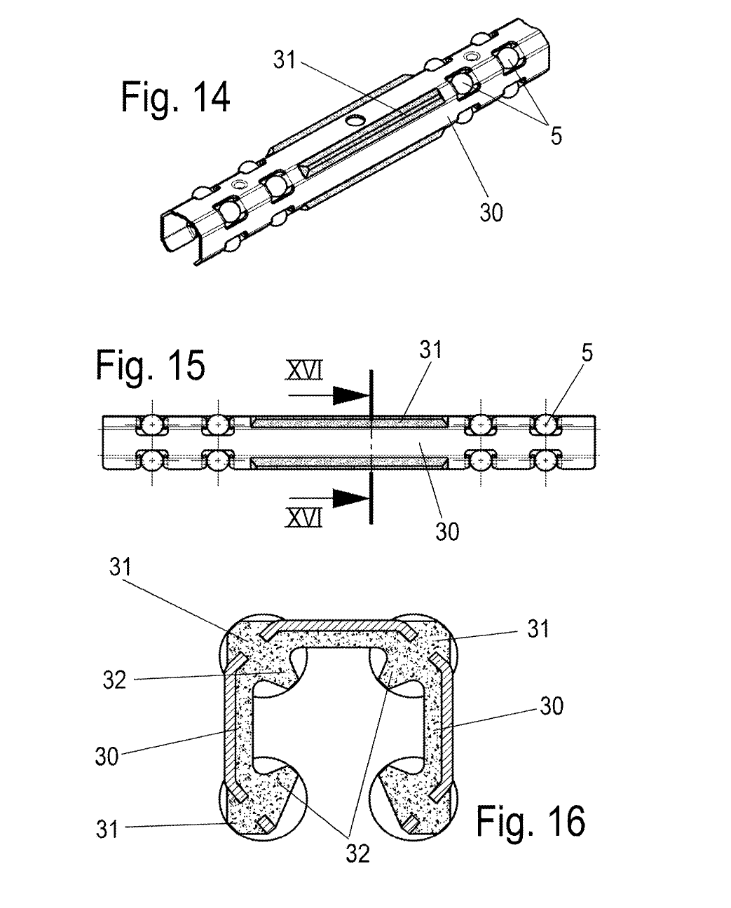

FIGS. 14 to 16 show another embodiment, according to the present disclosure, of a rolling element cage 30 in form of a strip-like rail made of a carrier material of higher strength, in which recesses or receivers are provided for accommodating rolling elements 5. The rolling elements 5 are mounted directly on the boundaries of the receivers. Several strips 31, made of a lubricant-containing material, are provided on a middle section at a distance from the rolling elements 5.

As is shown in FIG. 16, the strips 31 protrude on the outside to such an extent that they extend up to the outer circumference of the rolling elements 5 or slightly beyond. Further inwardly protruding strips 32, made of a lubricant-containing material, are provided on the inside of the rolling element cage 30, which strips 32 also protrude up to the outer circumference of the rolling elements 5. The strips 31 and 32 are, therefore, in contact with the running surfaces on the rails 2, 3 or 4 and can thus ensure application of lubricant when the rails 2, 3 and 4 are moved relative to one another.

The strips 31 and 32 are arranged integrally with one another and the individual strips 31, 32 are connected via webs 33 with each other. The strips 31 and 32 and the webs 33 can be applied in one coating step onto the rail of the rolling element cage 30.

The shape of strips 31 and 32 can, within the scope present disclosure, be varied. In particular, no elongated arrangement is necessary and projections with other geometries can be used for lubricating the running surfaces.

In a method for producing a pull-out guide 1, a guide rail 2 and at least one sliding rail 3 are produced at first by punching or bending of a metal sheet. Furthermore, one or several porous bodies, which forms or form at least one part of a rolling element cage 6, are impregnated with lubricant. The lubricant soaks into the porous body and can then be released at a later time. The impregnation process may be performed for a period of between 10 and 30 hours, and may be for 20 to 28 hours. The guide rail 2, the rolling element cage 6, and the at least one sliding rail 3 are then assembled into the pull-out guide 1, with lubrication of rolling elements 5 and the running surfaces or running paths 7, occurring by movement of the at least one sliding rail 3 relative to the guide rail 2.

The porous body for the rolling element cage 6 can be made of plastic by injection molding, or by two-component injection molding, in order to fix the plastic material simultaneously to the carrier material.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A pull-out guide for furniture, the pull-out guide comprising:
a guide rail configured to be mounted on a furniture body;
at least one sliding rail displaceably mounted via rolling elements on the guide rail; and
wherein the rolling elements are held in a rolling element cage, which cage includes a lubricant-containing material.

2. The pull-out guide according to claim 1, wherein the rolling elements slide on the lubricant-containing material via a contact surface.

3. The pull-out guide according to claim 2, wherein the rolling elements are wetted on the contact surface via the lubricant-containing material during a movement of the pull-out guide).

4. The pull-out guide according to claim 1, wherein the lubricant-containing material is a porous body made of one of a sintered material and plastic, in which oil is incorporated as a lubricant.

5. The pull-out guide according to claim 1, wherein the rolling elements are included in a rolling element cage which is made of the lubricant-containing material.

6. The pull-out guide according to claim 5, wherein the rolling element cage includes a plurality of recesses in each of which recesses a rolling element holder, made of a lubricant-containing material, is incorporated, and each rolling element holder includes one of the rolling elements.

7. The pull-out guide according to claim 6, wherein the rolling element holder is fixed to the rolling element cage.

8. The pull-out guide according to claim 1, wherein the rolling element cage is arranged in a strip-like manner and comprises individual receivers for rolling elements, with at least a region of the receivers being coated with the lubricant-containing material.

9. The pull-out guide according to claim 1, wherein the rolling element cage includes protruding strips which extend up to an outer circumference of the rolling elements or beyond.

10. The pull-out guide according to claim 9, wherein each strip is in contact with a running surface of one of the rolling elements on the guide rail or the at least one sliding rail.

11. A method for producing the pull-out guide according to claim 1, the method steps comprising:
punching and bending of the guide rail and the at least one sliding rail;
impregnating at least one porous body with a lubricant, which body forms at least part of the rolling element cage;
assembling the guide rail, the rolling element cage and the at least one sliding rail into the pull-out guide; and
lubricating the rolling element and running paths for the rolling element by moving the at least one sliding rail relative to the guide rail.

12. The method according to claim 11, wherein the porous body is impregnated with the lubricant over a period of more than two hours.

13. The method according to claim 11, wherein the porous body is saturated with the lubricant via a high-pressure process to obtain the lubricant-containing material.

14. The method according to claim 13, wherein the high-pressure process is carried out at pressures of more than 4 bars, but not more than 15 bars.

15. The method according to claim 11, wherein the rolling element cage includes a strip carrier material, on which a porous body is coated.

16. The method according to claim 15, wherein the carrier material is coated at opposite ends with the porous body and recesses are formed on the porous body which are configured to accommodate the rolling element.

17. The pull-out guide according to claim 6, wherein the rolling element holder is fixed to the rolling element cage in one of a positive and non-positive bonded way.

18. The method according to claim 11, wherein the porous body is impregnated with the lubricant over a period of more than 10 hours.

19. The method according to claim 11, wherein the rolling element cage includes a strip carrier material in which a porous body is mechanically fixed.
